(19) United States
(12) Patent Application Publication
(10) Pub. No.: US 2010/0243094 A1
(43) Pub. Date: Sep. 30, 2010

(54) Heat-sealable tubular laminate

(75) Inventors: Juergen Arz, Muenchen (DE); Harry Johlke, Gaissach (DE); Georg Pescher, Lenggries/Bad Toelz (DE)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: CCL LABEL GmbH, Holzkirchen (DE)

(21) Appl. No.: 11/814,951

(22) PCT Filed: Jan. 26, 2006
(86) PCT No.: PCT/EP06/00685

§ 371 Date: Apr. 10, 2008

(30) Foreign Application Priority Data
Jan. 27, 2005 (DE) 10 2005 003 922.7

(51) Int. Cl. F16L 55/00; B32B 27/32; B32B 3/10; B32B 7/02; B32B 37/04; F16L 9/12

(52) U.S. Cl. 138/103; 428/523; 428/195.1; 428/213; 156/160; 138/171

(57) ABSTRACT

The invention relates to a polymer film laminate (1), which can be heat-sealed to form tubular packaging, in particular a tube and which comprises at least one self-sealing outer printed film (5) consisting of an HDPE-based material and an inner polymer self-sealing support film (3) that is connected to the printed film (5) and whose melting point is identical to or a maximum 200° C. less than that of the printed film (5). The edges of the tube can abut or overlap to form the tube seam. If the seam edges abut and form a height misalignment (h) between opposing seam edges (1a, 1b), the support film (3) of one edge bonds to the printed film (5) of the opposing edge, maintaining a highly stable seam even under said conditions.

The invention relates to a sealable polymer film laminate for production of tubular packaging, which is in particular a tube, to a shaped tubular packaging produced therefrom, and also to a process for production of this shaped product. The laminate permits fractureproof welding of its longitudinal margins to give a continuous tube which is suitable for production of high-quality plastics tubes, pockets, bags, and the like.

EP 0 622 181 discloses, for example, a multilayer tubular laminate which comprises a plurality of polyethylene films which have been bonded to one another with the aid of the following: lamination, a support film, an ionomer layer, an intermediate film, and a further lamination.

EP 0 939 037 discloses a further film laminate for production of a tube, its external side having hologram-like appearance. The outer film here can be printed either on the external side or on the underside, by reverse printing.

The tube weld seam in these film laminates is produced via overlapping, and in the overlap region here the inner film of one laminate margin is sealed to the outer film of the other laminate margin. The two materials therefore have to have been produced from the same type of plastic, since otherwise it would not be possible to produce a seal seam.

Disadvantages are not only the resultant restriction on the selection of material but also possibly impairment of the printing process by these sealable materials. Relatively high-transparency films resistant to tension and to heat (“rigid films”) are preferable because they favor an accurate printed image, in particular in multicolor printing. On the other hand, a more flexible (“softer”) material of rather low melting point is preferable for internal shaping of the tube, but is more difficult to print. These different types of film then have different sealing temperatures. It can therefore be necessary, during the welding process, to subject the outer film to relatively high temperatures, in order that sealing extends to this region, but then the inner, softer film could become overheated, the possible result being burning of the internal film and defective sealing, due to inadequate compatibility of the different polymers. It is difficult to achieve the esthetically preferred butt welding of the longitudinal margins with such materials, since if there is a shift in height of the laminate margins perpendicularly with respect to the plane of the laminate, there is likewise a shift of the boundary between internal layer and external layer, and in this region of shift the welding between internal layer and external layer does not give a result which is homogeneous, low-stress, and stable.

It is therefore an object of the invention to provide a polymer film laminate which is sealable to give tubular packaging, which is in particular a tube, and which can achieve high seal seam strength together with good printability and, if appropriate, high transparency of the external layer.

The proposal to achieve the object comprises a polymer film laminate sealable to give tubular packaging which is in particular a tube, and comprising at least one self-sealable exterior print film composed of material based on high-density polyethylene (HDPE), and comprising, bonded thereto, an interior polymer support film which is self-sealable and sealable to the print film, and whose melting point is the same as or at most 20° C. lower than that of the print film.

Use of this laminate permits formation of an overlapping tube seam, in the conventional manner, and indeed with a butt seam which is optically particularly unobtrusive, even when a slight height shift occurs between the opposite laminate margins here, perpendicularly with respect to the plane of the laminate. Since the difference between the melting points of the print film and of the support film is at most 20° C., a low-stress, homogeneous weld can be produced between the two films, using a moderate temperature. The support film is usually composed of LDPE, which can be welded to abovementioned HDPE. If the slight height shift mentioned then occurs between the two film margins at the butt weld seam, a bond is formed in this shift region between the print film of one of the margins and the support film of the opposite margin, without any separation of the seam. This method gives optical properties in low-stress shaped tube products with a homogeneous weld seam. At the same time, the use of the print film composed of HDPE, which is highly resistant to tension and has good transparency, can give an accurate printed image.

The print film and the support film can be single- or multilayer films. In particular in the latter case, it is preferable that the melting point of the support film at least in the region of its side facing toward the print film and/or facing away therefrom, is equal to or at most 20° C. lower than the melting point of the print film, at least in the region of its side facing toward the support film and/or facing away therefrom, whereas these melting-point conditions do not necessarily have to be met, but can be met, by regions situated between these, or by sublayers of the print film and of the support film.

The support film can have a support function during production and/or in the laminate, but it is also possible for this support function to be assumed by the print film or by another film constituent of the laminate.

In principle, the inventive laminate is also suitable for overlap welding of the tube seam, in which the internal side of the support film is in contact with the external side of the print film and is welded thereto. This, too, gives a low-stress shaped tube product with a homogeneous weld seam.

The print film can in principle have been printed internally and/or externally, and, if there is print applied only on the external side, the print film itself can be an opaque or colored film, and in particular also can be metallized film. If there is internal print, the print film is transparent. It is possible to stretch the print film to a greater extent in the longitudinal direction of the tube, i.e. in the machine direction, than perpendicularly thereto. It is also possible to stretch the print layer preferably in the longitudinal direction of the tube and then to heat-set it, in order to achieve thermal/dimensional stability. The stretching process has generally been adjusted so as to achieve the necessary mechanical properties of the film together with maximum transparency.

It is preferable that the secant modulus of the print layer is ≧800 MPa to DIN 527/ASTM D882 for 2% tensile strain at a temperature of 23° C., together with good weldability to the support film, permitting particularly accurate printability.

The melting point of the print film is preferably from 114° C. to 136° C., by the ISO 1133 DSC measurement method. The support film which is internal with respect to the tube has been produced from material softer than that of the print film, and preferably also from material based on LDPE, which has good sealability to the HDPE of the print film while at the same time being sufficiently soft to provide the desired tactile and shaping properties of the subsequent tube.

The LDPE content of the support film is preferably more than 50%, based on volume, or, in the case of a multilayer support film, based on the thickness of the same.

The print film can have been bonded to the support film by means of a lamination layer. This permits problem-free bonding of these two films even when there is a print, or else some other decorative materials, for example metallization, applied between these. This lamination layer can at the same time assume the function of a barrier layer which inhibits diffusion of volatile substance through the at least one film, e.g. diffusion of atmospheric oxygen into the tube contents, or diffusion of flavors or the like out of the tube contents. UV protection can also be achieved using suitable additives.

In addition, or irrespective thereof, the support film can be a multilayer film and have its own sealable layer or barrier layer, this being an intermediate ply in the case of a multi-ply support film.

It is preferable that the support film is thicker than the print film, the preferred thickness of the support film here being from 1.5 to 40 times, preferably from 2 to 15 times, with preference from 5 to 10 times, the thickness of the print film (e.g.: 40μ).

A further object of the invention is to provide a shaped tubular packaging produced from the above film laminate, where the laminate margins of the packaging have been welded securely to one another.

To this end, the invention proposes a shaped tubular packaging composed of the laminate described above, the edges of whose opposite laminate margins have been butt-welded to one another. By virtue of the mutual weldability of print film and support film, welding between print film and support film occurs even if there is a height shift between the opposite laminate edges, giving good optical properties together with a low-stress shaped tube product with a homogeneous weld seam. In order to achieve a further increase in the stability of the weld seam, it is preferable that the laminate margins have been cut obliquely, using an angle of from 30° to 90°, preferably from 40° to 60°, with respect to the plane of the laminate, and welded.

As an alternative, the laminate margins in the shaped tubular packaging produced from the above laminate can have been overlap-welded, by a method where, in the region of overlap, the internal side of the support film of one of the laminate margins has been welded directly to the external side of the print film of the other laminate margin.

A still further object is to provide a process for production of a shaped tubular packaging from the above film laminate by permitting the laminate margins to be securely welded to one another.

To this end, the invention proposes a production process for a shaped tubular packaging in which the above sealable polymer film laminate is provided and the opposite margins of the laminate are joined to form a tube and are welded at a temperature at which the support film of one margin fuses with the opposite print film of the other margin.

In the case of a butt weld seam, the result is secure welding between print film and support film across the seam, even if the abovementioned height shift should occur between the opposite margins. Here, too, the possibility of forming an overlapping seam is an alternative.

Inventive examples are used below to illustrate the invention with reference to the drawings attached.

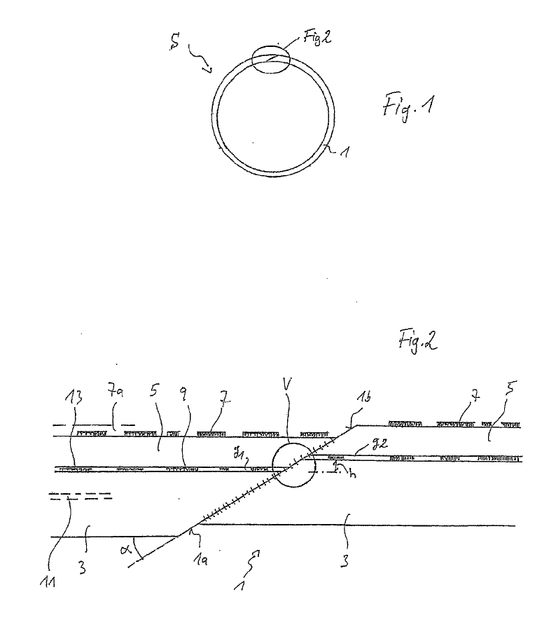

FIG. 1 shows a diagrammatic cross section through a first embodiment of a film laminate butt-welded to give an endless tube;

FIG. 2 shows an enlarged view of the seam region circled in FIG. 1;

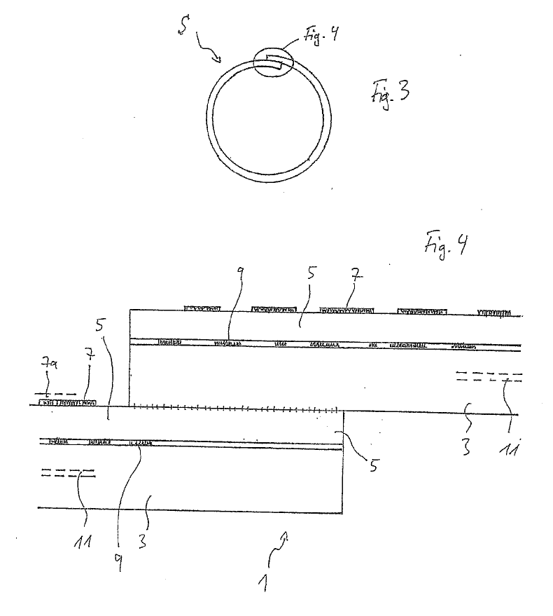

FIG. 3 shows a diagrammatic cross section through a second embodiment of a film laminate overlap-welded to give an endless tube; and

FIG. 4 shows an enlarged view of the seam region circled in FIG. 3.

FIGS. 1 and 2 describe a first embodiment. Opposite longitudinal margins of an endless strip composed of polymer film laminate 1 are to be joined to give a tube S, as shown in diagrammatic section in FIG. 1. This tube S serves as a basis for tubular packaging, for example tubes, bags, pockets, etc. As shown in cross section in FIG. 2, which shows an enlargement of the seam region circled in FIG. 1, the film laminate 1 encompasses a thick, relatively soft support film 3, interior with respect to the tube, as shaping material for the subsequent tubular packaging and, bonded thereto, thinner exterior print film 5 which is relatively rigid and therefore has good printability, composed of HDPE (high-density polyethylene) as support for decorative print 7, 9.

The support film 3 has been produced from a material, preferably material mainly comprising LDPE (low-density polyethylene), whose melting point is at most 20° C. below that of the print film 5 and which can therefore undergo problem-free welding directly thereto. The support film 3 itself can be a single- or multilayer film, and in the latter case can comprise a barrier layer 11 which inhibits diffusion of volatile substances, such as atmospheric oxygen or flavors, through the laminate. The print film and the support film 3, 5 have generally been bonded to one another by means of a thin lamination layer 13, in particular in the case of an internal print 9. The lamination layer 13 can likewise be a barrier layer. In the case of an external print 7, this can have been covered by a lacquer layer 7a. Functional properties can at the same time be achieved by way of this lacquer layer, examples being feel, mattness, or UV protection.

When the film laminate 1 is molded to give a tube S, the edges 1a, 1b of the opposite longitudinal margins of the film laminate 1 are butt-welded to one another, as shown in FIG. 2. A certain height shift h perpendicular with respect to the plane of the laminate is often unavoidable here, the result being that the boundary g1 between the two films 3, 5 of one laminate margin has been shifted with respect to the boundary g2 between the two films 3, 5 of the other laminate margin, perpendicularly with respect to the plane of the laminate, and in this overlap region V the support film 3 of one of the laminate margins can be directly welded to the print film 5 of the other laminate margin, as shown in the circled region in FIG. 2.

There is direct contact here between the print film 5 of the left-hand laminate margin in FIG. 2 and the support film 3 of the right-hand laminate margin in FIG. 2. Because of the mutual weldability of the materials, a stable bond is produced between the two films 3, 5, and the two edges 1a, 1b of the laminate can therefore be welded to one another completely and without any gaps, across the entire width of the seam.

In principle, the weld seams can run at an angle of 90° with respect to the plane of the laminate. In order to achieve ideal appearance of the seal seam together with high strength, it is preferable that, as shown, the edges for sealing are cut at complementary angles α and welded while situated obliquely against one another. The angle α of cut here is about 45° to 30° with respect to the plane of the laminate.

In other respects, the selection of material for the two films 3, 5 is determined by the sealing temperature and by transparency. For the sealing process, it is preferable to use high-frequency welding with independent internal and external generators. Another possibility is welding by means of ultrasound, laser, or thermal and adhesive methods.

FIGS. 3 and 4 show an alternative embodiment. The layer structure of the film laminate 1 is identical with that of the above embodiment, and the same parts have the same reference numerals, and no further description of these is given. Unlike the above embodiment, however, the tube seam here is formed via an overlap seam, where in the overlap region the internal side of the support film 3 has been welded directly to the external side of the print film 5 of the opposite film margin.

If the total thickness of the film laminate 1 is from 160 to 500 μm, preferably from 250 to 400 μm, the thickness of the support film is from 150 to 400 μm and that of the print film is from 10 to 100 μm, preferably from 20 to 60 y, particularly preferably from 30 to 50μ.

The external print film 5 can generally be a single- or multilayer film, and can have been printed on its internal and/or external side. In the case of print 7 applied only externally, the external side of which can in turn have been protected via the lacquer layer 7a or the like, the print film 5 can be an opaque or colored film. If an internal print 9 has been applied, the print film 5 is transparent, and uncolored or colored. The film can have been specifically stretched here in order to promote strength and transparency, e.g. stretched to a greater extent in the direction of running of the machine, this direction corresponding to the longitudinal direction of the tube, than in the perpendicular direction. After the stretching process, the print film 5 can be heat-set. The print 7, 9 can have been partially omitted in order to permit viewing of the contents if the support film 3 is transparent. The print applied can also have been metallized in order to promote a high-gloss effect.

The print film 5 can have been rendered matte, can provide a mother-of-pearl effect, can have barrier properties, can provide protection from UV and from light, and can have soft-touch effects. Other properties than can be achieved using the print film 5 are: metallic high-gloss effects, hot-stamping-foil effects, sterilization, antistatic properties, thermo-chromatic effects, chemical indication, electrical conductivity, etc.

The print film 5 is printed on one or both sides by normal printing or reverse printing and/or decorated by the stamping process, using rolls. When the selected print film is used there is no restriction on the selection of the printing processes, particularly for combination printing, resulting by way of example from thickness variations or thermal/mechanical deformation of the print film. It can be a monofilm, coextruded film, multilayer film, or laminated film. It is also possible to apply a print involving full-surface metallic high-gloss effects. If the high-gloss effect is partially omitted, giving a view of the contents, this in combination with relatively high wall thicknesses of the individual films can achieve three-dimensional effects.

The print film 5 can be printed using solvent inks or lacquers, digital toners, UV ink systems, or solvent-free ink systems, or else water-thinnable ink systems and water-thinnable lacquer systems.

The print film 5 protects the print 9 applied on the underside from abrasion and product-related effects. It also gives a particular gloss and brilliance of the colors used, in particular to metallic colors, also in combination with a high-gloss and matt-metallic appearance. One particularly suitable material for the print film 5 is an HDPE whose melt flow index (MFR) to ISO 1133, method B, 190° C./2.16 kg, is from 0.5 to 0.9, preferably 0.73.

The mechanical properties of the print film 5 were determined by the DIN 527/ASTM D882 tensile test. Mechanical properties are important for the dimensional stability of the print film 5, in order to permit printing with precise register. The secant modulus of elasticity of the inventive print film materials here is ≧800 MPa for tensile strain of 2% at a temperature of 23° C.

The density of the HDPE films used for the print film 5 is greater than 0.94 to 0.977 g/cm³ and their melting point is from 128 to 136° C. Particularly high trans-parency is achieved using metallocene-catalyzed HDPE grades. Other plastics can also have been admixed with the HDPE, examples being propylene, copolymers composed of propylene and ethylene, such as random copolymers, block copolymers, or graft copolymers. These products can give particularly high seal seam strength using PE-based laminate as a function of melt viscosity, of melting point, and also of PE/PP ratio.

The print films 5 can take the form of monoaxial or biaxially oriented films. The orientation process can be carried out sequentially or simultaneously. The molecular chains oriented in this process give the print film 5 higher transparency and tensile strength. The print films can also take the form of cast films. The print film 5 can also have been treated by plasma coating in order, for example, to obtain oxygen-barrier function or aroma-barrier function. Similarly good barrier action is obtained using SiOx, where x is preferably from 1.2 to 1.7, applied via electron-beam vaporization or high-vacuum vaporization. Nanoparticles can give the films barrier properties and UV protection.

The internal support film 3 can likewise be a single- or multilayer film, e.g. a monofilm, a coextruded film, a multilayer film, or a laminated film. It, too, can itself have the print 9 applied if the print film 5 is transparent, and the printing inks that can be used here are the same as those for the print film 5. The support film 3 here is composed mainly of LDPE (low-density polyethylene), and this means that the proportion by volume of LDPE in the support film 3 is greater than 50%. In the case of a multilayer structure, this value is also based on the proportion of the thickness of LDPE in the support film 3.

The melting point of the support film 3 here by the ISO 1133 DSC measurement method is from 108 to 125° C. The support film 3 gives the subsequent tube stability, protection from product, and processability. A wide variety of multilayer laminates can be used here, preference being given to multilayer embodiments, and the individual layers here can have different functions.

Materials that can generally be used for the support film 3 are:
Polyethylene (PE): high-density polyethylene (HDPE) whose density is greater than 0.94 to 0.977 g/cm³, melting point from 128 to 136° C., medium-density polyethylene (MDPE) whose density is from 0.926 to 0.944 g/cm³, melting point from 120 to 136° C., linear medium-density polyethylene (LMDPE) whose density is from 0.926 to 0.940 g/cm³, low-density polyethylene (LDPE) whose density is from 0.90 to 0.93 g/cm³, melting point from 100 to 130° C., linear low-density polyethylene (LLDPE) whose density is from 0.916 to 0.925 g/cm³, melting point from 105 to 115° C.
Use of metallocene-catalyzed PE grades is advisable in order to achieve high-transparency PE films.
Polypropylene (PP): amorphous, crystalline, or highly crystalline polypropylene, atactic or isotactic or syndiotactic PP. Either cast or BOPP films can be used here. Films can be optimized with respect to their mechanical, optical, and thermal properties as a function of the catalyst technology used, of molecular-weight distribution, and of process properties.
Copolymers composed of propylene and ethylene, and these can be random copolymers, block copolymers, or graft copolymers.
The use of these products can give high seal seam strengths using PE-based tubular laminates, as a function of melt viscosities, of melting points, and also of PE/PP ratio. Random copolymers intrinsically have the property of high transparency, and this can be further improved via appropriate processing, e.g. stretching.
Ionomer resins, such as Surlyn from DuPont, can be used alone or in the form of a mixture with the polymers described, in order to influence the transparency, sealing properties, and barrier properties of the support film.
The use of polyolefin resins, e.g. Adsyl (Basel), in coextrusion with PE or PP grades, can give films which are mechanically stable and have good sealing properties, for bonding to give tubes.
Polyvinyl-based products can give oxygen-barrier properties, examples being polyvinyl alcohols, polyvinyl acetates, etc.
Polyesters (e.g.: polyalkylene terephthalate, polyalkylene isophthalate, or polyalkylene naphthalate, or analogous naphthalates typically having alkylene groups having from 2 to 20 carbon atoms or alkyl groups interrupted by at least one oxygen atom and having from 2 to 60 carbon atoms, or copolymers of the monomers underlying these with glycol or other polyhydric alcohols. The copolymer of terephthalic acid and ethylene glycol with a further glycol or glycol-modified polyester—known as PETG, is particularly advantageous, as also, however, are other grades known as APET, PETP, or GPET).
Polyamides (e.g.: nylon-6, nylon-11, nylon-12, nylon-6,6, nylon-6,10; nylon-6,12; nylon-6,3,T, and also mixtures of these) or other polyolefins (e.g. poly-1-butene, poly-3-methylbutene, poly-4-methylpentene, or polymers of other suitable monomers, or mixtures composed of such monomers, homopolymers, or copolymers) and copolymers (block copolymers, random copolymers, or graft block copolymers) of these materials with one another or with, for example, vinyl acetate or acrylic acid, or mixtures of these materials with elastomers or fillers.
Polystyrene
Cycloolefin copolymer (COC) or metallocene-polymerized COC (MCOC). The COCs are generally homopolymers or copolymers with high-transparency surface.
Aluminum foils whose thickness is generally from 5 to 40μ can be laminated into the structure of the film as barrier.

The support film 3 can have, on its external side, or in the multilayer composite, at least one barrier layer 11 which inhibits diffusion of volatile substances from the contents to the outside or else inhibits diffusion of constituents of the atmosphere, in particular O₂, through the laminate into the contents. In the case of exterior printing of the print film 5 and, if appropriate, also if there are gaps in the interior printing of the print film 5 with no full-surface metallization, the print film 5 can have been sealed directly to the support film 3 over the entire surface.

However, in the case of full-surface printing of the internal side of the print film 5, also possibly with additional metallization, it is preferable to bond the two films 3,5 by means of a lamination layer 13 which simultaneously serves as a barrier for volatile substances diffusing through the laminate 1.

The lamination system 13 can be produced by a lacquer lamination or dry lamination process using solvent-containing or solvent-free adhesives, aqueous dispersion adhesives, 2-component reactive adhesives, UV-reactive lamination adhesives, or heat-sealing lacquers. Base polymers that can be used are the familiar products, examples being alpha-olefins, PET, PU, epoxy, acrylate, PVC, PVAc, PVOH, etc.

Application of a hot-melt adhesive improves properties in the seal seam, e.g. strength.

It is preferable to use solvent-containing single- or multicomponent lamination adhesives based on polyurethane (e.g.: Lamal HAS or Lamal 408/40 or Liofol UR 7780 or Liofol UR 3835 or Pentaflex 30-5100, in each case with the associated hardener system) or any other suitable lamination adhesive system.

The dry-weight amounts applied of the lamination adhesive are from 0.5 to 20 g/m², preferably from 2 to 10 g/m², particularly preferably from 2.5 to 6 g/m². Application takes place from a solution or dispersion whose solid content is from 25 to 75%, preferably from 30 to 66%, particularly preferably from 30 to 45%.

In the case of UV lamination systems, adhesives whose solids content is 100% can be used. This prevents blistering and haze in the laminated composite.

In order to increase laminate strength and to provide stabilization, the print film 5 and the support film 3 laminated to the material can be subjected to a flame- or corona-pretreatment, prior to printing and, respectively, lamination, in order to increase surface tension, with the aim of improving wetting and adhesion of printing inks and lamination adhesive. Any pretreatment present deriving from production of the film can be renewed in-line prior to the printing/lamination process.

Lacquer systems or coating systems can also be used as adhesion promoters (primers). Alongside conventional primers, it is also possible to use grafted photo-initiators in order to improve adhesion, an example being Prime IT from Ciba Geigy. These can have been applied either before film production was completed or else in a specific downstream process, or in-line, prior to printing/lamination. These lacquer systems or coating systems can have merely one function (e.g. adhesion improvement), or else can modify or improve a combination of one or more properties, for example adhesion, optical properties, barrier properties.

Nanoparticles or additives can be used to establish desired properties such as UV protection, aroma barrier, or scratch resistance.

The lacquer system 7a or coating can have been applied to one or both sides of one or more of the film composites or films used to produce the laminate composite.

1. A polymer film laminate (1) sealable to give tubular packaging which is in particular a tube, and comprising at least one self-sealable exterior paint film (5) composed of material based on high density polyethylene (HDE), and comprising, bonded thereto, an interior polymer support film (;) which is self-sealable and sealable to the print film (5), and whose melting point is the some as or at most 20° C. lower than that of the print film (5).

2. The laminate as claimed in claim 1, characterized in that the melting point of the support film (3), at least in the region of its side facing toward the print film and/or facing away therefrom, is equal to or at most 20° C. lower than the melting paint of the print film (5), at least in the region of its side facing toward the support film (3) and/or facing away therefrom.

3. Ice laminate as claimed in claim 1, characterized in that the print film (5) bears a print (7) on its external side and/or that the print film (5) is transparent and its internal side has a print (9) applied.

4. The laminate as claimed in claim 1, characterized in that the print film (5) has been stretched to a greater extent in particular in the longitudinal direction of the tube than perpendicularly thereto.

5. The laminate as claimed in claim 1, characterized in that the print film (5) has been stretched in the longitudinal direction of the tube and has been mechanically set/heat-set.

6. The laminate as claimed in claim 1, characterized in that the secant modulus the print film (5) is ≧800 MPa to DIN 527/ASTM D882 for 2% tensile strain at a temperature of 23° C.

7. The laminate as claimed in claim 1, characterized in that the melting point of the print film (5) is from 114° C. to 136° C.—according to the ISO 1133 DSC measurement method.

8. The laminate as claimed in claim 1, characterized in that the support film has been produced from material based on low-density polyethylene (LOPE).

9. The laminate as claimed in claim 8, characterized in that the LOPE content of the support film (3), based on the volume or the thickness of the support film (3), is more than 50%.

10. The laminate as claimed in claim 1, characterized in that the melting point of the support film (3) is from 108° C. to 125° C.—according to the ISO 1133 DSC measurement method.

11. The laminate as claimed in claim 1, characterized in that the print film (5) has been sealed directly to the support film (3).

12. The laminate as claimed in claim 1, characterized in that the print film (5) has been bonded by means of a lamination layer (13) to the support film (3).

13. The laminate as claimed in claim 12, characterized in that the layer (13) has been designed as a barrier layer (13) for substances diffusing through at least one of the films (3, 5).

14. The laminate as claimed in claim 1, characterized in that a barrier layer (13, 15) for substances diffusing through at least one of the films (3, 5) has been provided in or on the support film (3).

15. The laminate as claimed in claim 1, characterized in that the support film (3) thicker than the print film (5).

16. The laminate as claimed in claim 15, characterized in that the thickness of the support film (3) is from 1.5 to 40 tames, preferably from 5 to 20 times, particularly preferably from 10 to 15 times, the thickness of the print film (5).

17. A shaped tubular packaging (S), in particular for a tube, produced from a polymer film laminate (1) as claimed in claim 1, the edges (Ia, Ib) of whose opposite laminate margins have been butt-welded to one another.

18. The shaped tubular packaging (S) as claimed in claim 17, characterized in that the laminate margins have been welded at an angle (a) of from 30° to 90°, preferably from 40° to 600, with respect to the plane of the laminate.

19. The shaped tubular packaging (S) as claimed in claim 17, characterized in that the boundary (g1) between print film and support film (3, 5) of one of the laminate margins has been shifted with respect to the boundary (g2) between print film and support film (3, 5) of tie or laminate rain, transversely with respect to the plane laminate, and in this overlap region (V) the support film (3) of one of the laminate margins

20. A shaped tubular packaging (S), in particular for a tube, produced from a polymer film laminate (1) as claimed in claim 1, in which, in an overlap region of the opposite laminate margins, the internal side of the support film (3) of one of the laminate margins has been welded directly to the external side of the print film (5) of the other laminate margin.

21. A production process for a shaped tubular packaging (S), in particular a tube, encompassing: provision of a sealable polymer film laminate (1) as claimed in claim 1, and joining and welding of opposite edges of the poly-ma r film laminate (1) to form a tube (S) at a temperature at which the support film (3) of one of the laminate margins is welded to the print film (5) of the opposite other laminate margin.

22. The process as claimed in claim 21, characterized is that the margins of the film laminate (1) have been butt-joined and welded to one another at the Edges (Ia, Ib).

23. The process as claimed in claim 22, characterized in that the edges (Ia, Ib) of the laminate margins are cut obliquely prior to welding, preferably using an angle of from 30° to 90° with respect to tie plane of the laminate, particularly preferably from 40° to 60°.

24. The process as claimed in claim 21, characterized in that the opposite margins of the film laminate (1) are laid fiat one on the other so as to overlap, and the print film (5) of one of the laminate margins is welded directly to the support film (3) of the other laminate margin.

25. A laminate or a shaped tubular packaging (S) as claimed in claim 1, in which, in an otherwise full-surface-printed area, an area whose proportion is “X” has been omitted in order to permit viewing of the contents.
